(19) United States
(12) Patent Application Publication
(10) Pub. No.: US 2023/0207904 A1
(43) Pub. Date: Jun. 29, 2023

(54) RECOVERY PROCESSING METHOD OF LITHIUM ION BATTERY, CHARGE/DISCHARGE DEVICE AND STORAGE MEDIUM

(71) Applicant: HONDA MOTOR CO., LTD., Tokyo (JP)

(72) Inventors: Hodaka Tsuge, Wako-shi (JP); Seiichi Koketsu, Wako-shi (JP); Shunsuke Konishi, Wako-shi (JP); Hidetoshi Utsumi, Wako-shi (JP)

(21) Appl. No.: 17/975,648

(22) Filed: Oct. 28, 2022

(30) Foreign Application Priority Data
Dec. 28, 2021 (JP) 2021-214860

(51) Int. Cl. H01M 10/44; H01M 10/0525; H02J 7/00

(52) U.S. Cl. CPC H01M 10/44; H01M 10/0525; H02J 7/0048

(57) ABSTRACT

A recovery processing method of a lithium ion battery of an embodiment is a processing method of recovering performance of the lithium ion battery. The recovery processing method of the lithium ion battery includes a process of holding an SOC of the lithium ion battery at a fixed value that is within a range of 10% to 70%. The SOC in the process is preferably set to equal to or smaller than a value in which a gradient of an SOC-voltage curve has a minimum value.

### CROSS-REFERENCE TO RELATED APPLICATION

Priority is claimed on Japanese Patent Application No. 2021-214860, filed Dec. 28, 2021, the content of which is incorporated herein by reference.

### BACKGROUND OF THE INVENTION

### Field of the Invention

The present invention relates to a recovery processing method of a lithium ion battery, a charge/discharge device and a storage medium.

### Description of Related Art

In recent years, for the purpose of CO₂ reduction from the viewpoint of climate-related disasters, the interest in electric automobiles has increased, and use of lithium ion batteries for in-vehicle use is being considered.

Lithium ion batteries may experience a drop in performance due to repeated charge/discharge cycles. As a method of recovering the performance of a lithium ion battery, a method of placing the lithium ion battery under predetermined conditions has been proposed (for example, see Japanese Unexamined Patent Application, First Publication No. 2000-277164 and Japanese Unexamined Patent Application, First Publication No. 2021-103646).

### SUMMARY OF THE INVENTION

The above-mentioned technologies have not been sufficiently effective in recovering the performance of lithium ion batteries.

One of objects of the present invention is directed to providing a recovery processing method of a lithium ion battery, a charge/discharge device and a storage medium, which are excellent with regard to an effect of recovering the performance of lithium ion batteries.

A recovery processing method of a lithium ion battery, a charge/discharge device and a storage medium according to the present invention employ the following configurations.

(1) A recovery processing method of a lithium ion battery according to an aspect of the present invention includes a process of holding an SOC of the lithium ion battery at a fixed value that is within a range of 10% to 70%.

(2) In the aspect of the above-mentioned (1), the SOC in the process is set to equal to or smaller than a value in which a gradient of an SOC-open circuit voltage curve has a minimum value.

(3) In the aspect of the above-mentioned (2), the SOC in the process is set to equal to or smaller than a value in which the gradient of the SOC-open circuit voltage curve is two times of the minimum value.

(4) In the aspect of any one of the above-mentioned (1) to (3), prior to the process, whether there is a decrease in performance of the lithium ion battery is determined, and the process is performed only when a decrease in performance is confirmed.

(5) A charge/discharge device according to an aspect of the present invention is a charge/discharge device electrically connected to a lithium ion battery, the charge/discharge device including a controller configured to perform charge/discharge of the lithium ion battery, and the controller performs a process of holding an SOC of the lithium ion battery at a fixed value that is within a range of 10% to 70%.

(6) A non-transitory computer readable storage medium storing a program according to an aspect of the present invention is configured to cause a charge/discharge device electrically connected to a lithium ion battery to perform a process of holding an SOC of a lithium ion battery at a fixed value that is within a range of 10% to 70%.

According to the aspects of the above-mentioned (1) to (6), it is possible to provide a recovery processing method of a lithium ion battery, a charge/discharge device and a storage medium, which are highly effective in recovering performance of a lithium ion battery.

### BRIEF DESCRIPTION OF THE DRAWINGS

FIG. 1 is a perspective view of an example of a lithium ion battery.

FIG. 2 is a configuration view of a charge/discharge device.

FIG. 3 is a graph showing an example of variation in discharge capacity in a charge/discharge test.

FIG. 4 is a scanning electron microscope (SEM) image of a surface of a negative electrode of the lithium ion battery at the beginning of the charge/discharge test.

FIG. 5 is a SEM image on the surface of the negative electrode of the lithium ion battery at the end of the charge/discharge test.

FIG. 6 is a graph showing a relation between a holding voltage and a recovery rate.

FIG. 7 is a graph showing a relation between an SOC, an OCV and a recovery rate.

FIG. 8 is a graph showing an example of a relation between an SOC, a gradient of an SOC-OCV curve, and a recovery rate.

FIG. 9 is a graph showing a relation between an SOC, an OCV, and a gradient of an SOC-OCV curve.

FIG. 10 is a graph of a test result.

### DETAILED DESCRIPTION OF THE INVENTION

Hereinafter, embodiments of a recovery processing method of a lithium ion battery, a charge/discharge device and a storage medium of the present invention will be described with reference to the accompanying drawings.

### [Lithium Ion Battery]

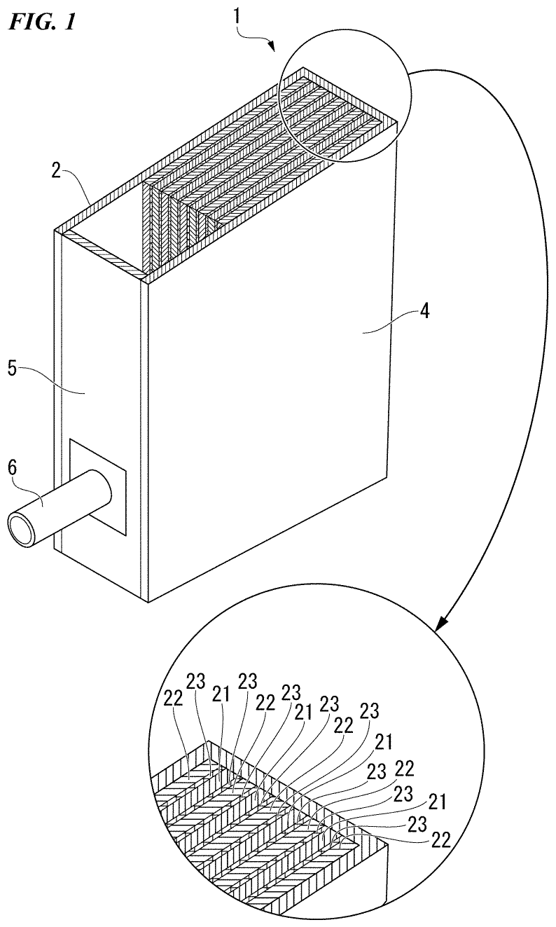

FIG. 1 is a perspective view of an example of a lithium ion battery.

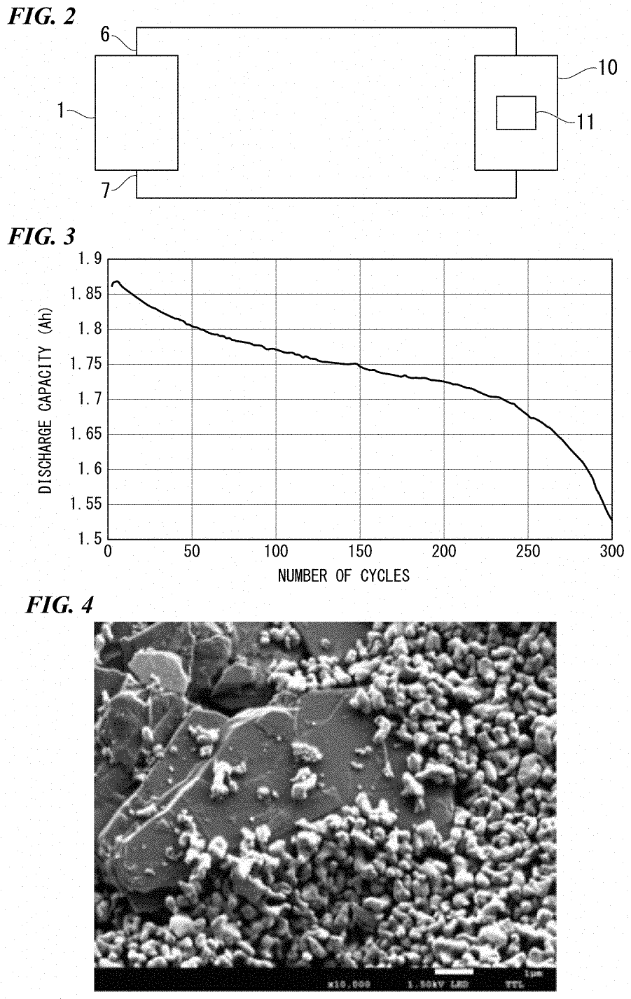

As shown in FIG. 1, a lithium ion battery 1 includes a laminated body 2 including an electrode, an exterior body 4 configured to accommodate the laminated body 2, and a lid body 5 configured to seal the exterior body 4. The exterior body 4 is, for example, a housing formed of a metal. A positive electrode terminal 6 and a negative electrode terminal 7 (see FIG. 2) are provided in the exterior body 4 or the lid body 5.

The laminated body 2 includes a positive electrode 21, a negative electrode 22, and a separator 23. The separator 23 is interposed between the positive electrode 21 and the negative electrode 22. The positive electrode 21, the negative electrode 22 and the separator 23 are impregnated with an electrolytic solution.

The positive electrode 21 has a positive electrode collector and a positive electrode active material layer. The positive electrode active material is, for example, a lithium complex oxide containing nickel, cobalt, and the like. The lithium complex oxide is, for example, a lithium nickel complex oxide, a lithium cobalt complex oxide, a lithium manganese complex oxide, a lithium nickel cobalt complex oxide, a lithium nickel manganese complex oxide, a lithium nickel cobalt manganese complex oxide, or the like.

The negative electrode 22 has a negative electrode collector and a negative electrode active material layer. The negative electrode active material is a carbon material such as graphite or the like.

The separator 23 is formed of a resin such as polyethylene (PE), polypropylene (PP), or the like.

The electrolytic solution contains, for example, a nonaqueous solvent, and a lithium salt (electrolyte). As the nonaqueous solvent, ethylene carbonate (EC), propylene carbonate (PC), and diethyl carbonate (DEC) are exemplified. As the electrolyte, lithium hexafluorophosphate (LiPF6), lithium tetrafluoroborate (LiBF4), or the like, may be exemplified.

The lithium ion battery 1 is mounted on, for example, a vehicle.

### [Charge and Discharge Device]

FIG. 2 is a configuration view of a charge/discharge device 10 of the embodiment.

As shown in FIG. 2, the charge/discharge device 10 is electrically connected to the positive electrode terminal 6 and the negative electrode terminal 7 of the lithium ion battery 1. The charge/discharge device 10 includes a controller 11. The controller 11 can perform charge/discharge of the lithium ion battery 1 according to a recovery processing method, which will be described below. The charge/discharge device 10 may include a power supply configured to charge the lithium ion battery 1. When the power supply is not provided, an external power supply is used. The charge/discharge device 10 is mounted on, for example, a vehicle. The charge/discharge device 10 may be mounted on a battery exchanging device.

The controller 11 is realized by executing a program (software) using a hardware processor such as a central processing unit (CPU) or the like. Some or all of the components may be realized by hardware (a circuit part; including circuitry) such as a large scale integration (LSI), an application specific integrated circuit (ASIC), a field-programmable gate array (FPGA), a graphics processing unit (GPU), or the like, or may be realized by cooperation of software and hardware. The program may have been previously stored in a storage device such as an HDD, a flash memory, or the like, of the controller 11 (a storage device including a non-transient storage medium), and may be stored in a detachably storage medium such as a DVD, a CD-ROM, or the like, and installed in the HDD or the flash memory of the controller 11 by mounting the storage medium (non-transient storage medium) in a drive device.

### [Decrease in Performance of Lithium Ion Battery Due to Repetition of Charge/Discharge]

In the lithium ion battery, performance such as a discharge capacity is decreased by repeating charge/discharge. A cause of a decrease in performance is lithium (for example, dendrite) or the like precipitated on, for example, a negative electrode surface. The decrease in performance is likely to occur in a low temperature environment (for example, 0° C. or less).

FIG. 3 is a graph showing an example of a variation in discharge capacity in a charge/discharge test.

As shown in FIG. 3, in the lithium ion battery in the example, as a number of cycles (a number of repetitions) of charge/discharge increases a discharge capacity gradually decreases.

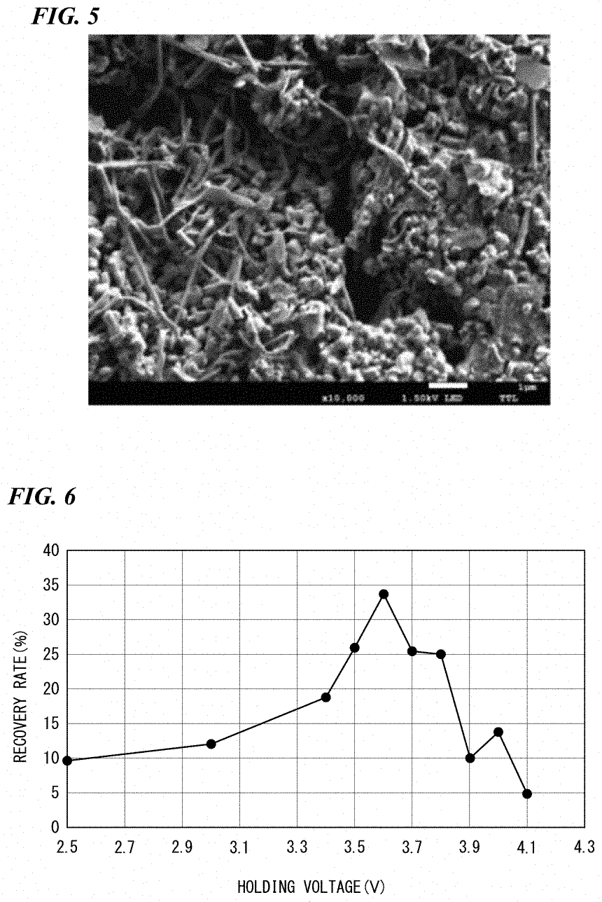

FIG. 4 is a scanning electron microscope (SEM) image of a surface of a negative electrode of a lithium ion battery at the beginning of a charge/discharge test. FIG. 5 is a SEM image on the surface of the negative electrode of the lithium ion battery at the end of the charge/discharge test.

As shown in FIG. 4 and FIG. 5, it can be seen that lithium (dendrite), which is a needle crystal, was formed on the surface of the negative electrode by repeating charge/discharge.

### [Recovery Processing Method of Lithium Ion Battery]

The lithium ion battery with a decrease in performance can exhibit performance recovery by the following method. A recovery processing method described below can be performed by the charge/discharge device 10 (see FIG. 2).

A process of holding an SOC of the lithium ion battery to a fixed value, which is within a range of 10% to 70%, is performed. In holding the SOC of the lithium ion battery to the fixed value, the following method can be used. After the SOC of the lithium ion battery is set to a predetermined value, electrical conduction to the lithium ion battery is stopped by releasing electrical connection between the lithium ion battery and the charge/discharge device, and the lithium ion battery is left as it is. A temperature of the lithium ion battery in the leaving duration is preferably constant.

When the SOC is 10% or more, since a voltage gradient on the negative electrode becomes smaller, decomposition of lithium (for example, dendrite) on a negative electrode surface is facilitated.

When the SOC is 70% or less, an amount of lithium ions occluded by the negative electrode can be suppressed, making it easier for the lithium ions to move. For this reason, decomposition of lithium (for example, dendrite) on the negative electrode surface can be promoted.

Accordingly, performance of the lithium ion battery can be recovered by holding the SOC to the fixed value, which is within a range of 10% to 70%.

A time for a process of holding the SOC of the lithium ion battery to the above-mentioned fixed value is, for example, 50 hours or more (preferably 200 hours or more). Accordingly, it is possible to promote decomposition of lithium-containing compound on the negative electrode surface and recover performance of the lithium ion battery.

The performance recovery of the lithium ion battery can achieve improvement in energy efficiency by prolonging the lifespan of the lithium ion battery.

In the recovery processing method of the embodiment, prior to the recovery processing including the above-mentioned process, whether or not there has been a decrease in performance of the lithium ion battery is determined, and the recovery processing may be performed only when a decrease in performance is confirmed. Whether or not there has been a decrease in performance can be determined on the basis of, for example, a recovery rate of the capacity. A non-operation period of the lithium ion battery can be shortened by determining whether or not there has been a decrease in performance.

Hereinabove, while the aspect performed by the present invention has been described using the embodiment, the present invention is not particularly limited to the embodiment and various modifications and substitutions may be made without departing from the scope of the present invention.

In holding the SOC to the fixed value, the SOC needs not to be strictly constant. For example, it can be considered to correspond to “holding to a fixed value” even when the SOC is increased or decreased within a range of ±10% with respect to a target value. Specifically, when the target value of the SOC is referred to as V, the SOC can be regarded as a fixed value as long as it is within a range of 0.9 V to 1.1 V.

Hereinafter, the present invention will be described in detail on the basis of a specific example. Further, the present invention is not limited to the following examples.

### Example 1

A lithium ion battery using lithium complex oxide of a ternary system containing cobalt, nickel and manganese as a positive electrode active material was prepared. A rated voltage was 3.6 V. A capacity was 3 Ah. An upper limit voltage was 4.2 V. A lower limit voltage was 2.5 V.

A capacity of the lithium ion battery is obtained as follows.

After the lithium ion battery is placed in a thermostatic oven at 25° C. and left 4 hours, the following operations were performed under a temperature condition of 25° C. in the thermostatic oven.

(1) The lithium ion battery is discharged to 2.5 V at a current of 3 A (corresponding to 1 C at a rated capacity) and left for 10 seconds.

(2) The lithium ion battery is charged to 4.2V at a constant current of 3 A.

(3) The lithium ion battery is charged at a constant voltage until the current becomes 0.6 A (corresponding to 0.2 C at a rated capacity) at a voltage of 4.2 V.

(4) The lithium ion battery is discharged to 2.5 V at a constant current of 3 A. A capacity upon the discharge is measured.

During the discharge (operation (4)), the voltage is measured at each second.

The SOC is calculated by “(capacity−current·time)/capacity×100(%).”

(Fabrication of Samples with Decrease in Performance)

The lithium ion battery was provided to the following charge/discharge test.

After the lithium ion battery was placed in a thermostatic oven at −10° C. and left for 4 hours, the following operations (A) and (B) were repeated by 300 cycles under a temperature condition of −10° C. in the thermostatic oven.

(A) The lithium ion battery is discharged to 2.5 V at a current of 9 A and left for 10 seconds.

(B) The lithium ion battery is charged to 4.2 V at a current of 9 A and left for 10 seconds.

Accordingly, a sample with a decrease in performance (degradation) was obtained.

### (Recovery Processing)

A holding voltage shown in Table 1 was applied to the above-mentioned sample using the charge/discharge device 10 (see FIG. 2) for 2 hours. Next, electrical conduction to the sample was stopped by releasing electrical connection to the charge/discharge device 10, and the sample was left at a temperature of 25° C. for 200 hours. During the leaving duration, the SOC was maintained at a fixed value shown in Table 1. The time during which the sample is left with the SOC as the fixed value is also called “holding time.”

An initial capacity of the lithium ion battery, a capacity after the decrease in performance (after degradation), and a capacity after recovery were measured by the above-mentioned capacity measurement method.

A recovery rate was calculated by the following equation.

Recovery rate=(capacity after recovery−capacity after degradation)/(initial capacity−capacity after degradation)

The result is shown in Table 1 and FIG. 6.

TABLE 1

| Holding | | | | | | | | | | |
|---|---|---|---|---|---|---|---|---|---|---|
| voltage (V) | 2.5 | 3.0 | 3.4 | 3.5 | 3.6 | 3.7 | 3.8 | 3.9 | 4.0 | 4.1 |
| SOC (%) | 0 | 1.8 | 7.4 | 12.9 | 27.6 | 49.2 | 64.1 | 75.1 | 85.6 | 95.9 |
| Initial capacity (Ah) | 2.97 | 2.90 | 3.15 | 3.10 | 2.98 | 3.15 | 3.06 | 3.07 | 2.88 | 2.97 |
| Capacity after | 2.35 | 2.32 | 2.25 | 2.33 | 2.27 | 2.29 | 2.30 | 2.37 | 2.30 | 2.35 |
| degradation (Ah) | | | | | | | | | | |
| Capacity after | 2.41 | 2.39 | 2.42 | 2.53 | 2.51 | 2.51 | 2.49 | 2.44 | 2.38 | 2.38 |
| recovery (Ah) | | | | | | | | | | |
| Recovery rate (%) | 9.68 | 12.07 | 18.89 | 25.97 | 33.80 | 25.58 | 25.00 | 10.00 | 13.79 | 4.84 |

As shown in Table 1 and FIG. 6, a recovery rate of the capacity was high when the holding voltage is 3.5 V to 3.8 V.

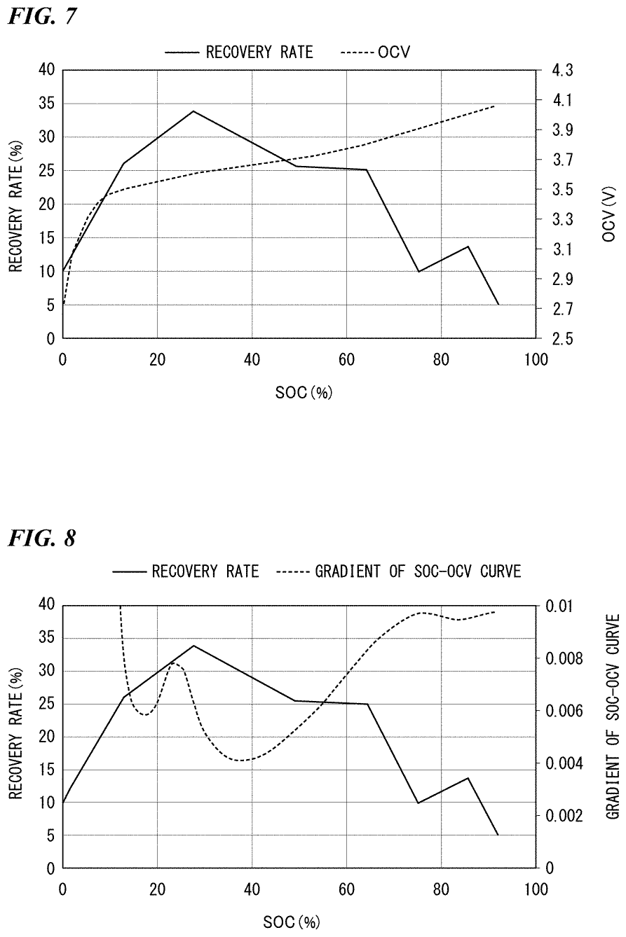

FIG. 7 is a graph showing a relation between an SOC, an open circuit voltage (OCV) and a recovery rate. A curve shown by a broken line in FIG. 7 is an example of “an SOC-OCV curve” (an SOC-open circuit voltage curve) expressing a relation between the SOC and the open circuit voltage (OCV). A lateral axis of FIG. 7 shows the SOC (%). A vertical axis of FIG. 7 shows an OCV (V), and a recovery rate (%). The OCV is, for example, a value obtained by subtracting a negative electrode potential (OCP) from a positive electrode potential (OCP).

The SOC-OCV curve was obtained as follows. The lithium ion battery is charged/discharged at a current of 0.6 A (corresponding to 0.2 C at a rated capacity), and an average of the charge voltage and the discharge voltage at the same SOC is referred to as the OCV. The SOC-OCV curve was created using the SOC and the OCV.

FIG. 8 is a graph showing an example of a relation between an SOC, a gradient of an SOC-OCV curve, and a recovery rate. A lateral axis of FIG. 8 shows an SOC (%). A vertical axis of FIG. 8 shows a gradient of an SOC-OCV curve, and a recovery rate (%). The gradient of the SOC-OCV curve is a proportion (V/%) of a variation amount of the OCV (V) with respect to a variation amount (%) of the SOC.

The gradient of the SOC-OCV curve is a linear gradient obtained by linearly approximating a range of the SOC from 30 seconds before to 30 seconds after the present time point by using a least square method, regarding the SOC and the voltage.

As shown in FIG. 7 and FIG. 8, the recovery rate was increased by setting the SOC to 10% to 70%. The gradient of the SOC-OCV curve is small at the SOC of 10% to 70%. For this reason, it is possible to stably recover performance of the lithium ion battery.

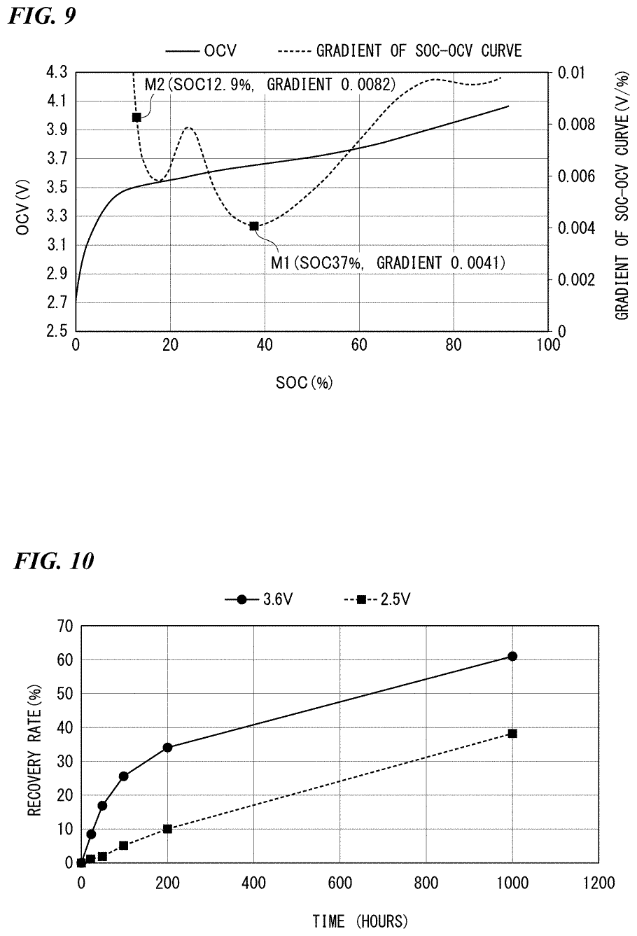

FIG. 9 is a graph showing a relation between an SOC, an OCV, and a gradient of an SOC-OCV curve. A lateral axis of FIG. 9 shows an SOC (%). A vertical axis of FIG. 9 shows an OCV (V), and a gradient of an SOC-OCV curve.

In FIG. 9, the SOC can be set below the value of the SOC at a point M1 where the gradient of the SOC-voltage curve is the minimum value. In the example shown in FIG. 9, the gradient of the SOC-OCV curve has a minimum value of 0.0041 at the point M1. The SOC at this time is 37%. For this reason, the SOC can be set to 37% or less.

By setting the SOC to be equal to or smaller than the value of the SOC at the point M1, the amount of the lithium ions occluded by the negative electrode can be reduced, and the lithium (for example, dendrite) can be easily decomposed in the negative electrode.

In FIG. 9, the SOC may be equal to or smaller than the value of the SOC at a point M2 where the gradient of the SOC-voltage curve is two times the minimum value. The SOC at the point M2 is smaller than the SOC at the point M1. In the example shown in FIG. 9, the gradient of the SOC-voltage curve has a value (0.0082) two times the minimum value of 0.0041 at the point M2. The SOC at this time is 12.9%. For this reason, the SOC is preferably 12.9% or less.

When the SOC is equal to or smaller than the value at the point M2, the lithium (for example, dendrite) can be easily decomposed in the negative electrode.

### Example 2

The recovery processing test was performed with the holding voltage and the holding time as shown in Table 2, and the recovery rate was calculated. Other methods conformed to Example 1.

The results are shown in Table 2 and FIG. 10.

TABLE 2

| | | Holding time (hours) | | | | | |
|---|---|---|---|---|---|---|---|
| | | 0 | 25 | 50 | 100 | 200 | 1000 |
| Holding voltage | 3.6 V | 0 | 8.45 | 16.9 | 25.3 | 33.8 | 60.56 |
| (V) | 2.5 V | 0 | 0 | 1.61 | 4.83 | 9.68 | 38 |

As shown in Table 2 and FIG. 10, the recovery rate was increased as the holding time is prolonged.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A recovery processing method of a lithium ion battery, the method comprising:
a process of holding an SOC of the lithium ion battery at a fixed value that is within a range of 10% to 70%.

2. The recovery processing method of the lithium ion battery according to claim 1, wherein the SOC in the process is set to equal to or smaller than a value in which a gradient of an SOC-open circuit voltage curve has a minimum value.

3. The recovery processing method of the lithium ion battery according to claim 2, wherein the SOC in the process is set to equal to or smaller than a value in which the gradient of the SOC-open circuit voltage curve is two times of the minimum value.

4. The recovery processing method of the lithium ion battery according to claim 1, wherein, prior to the process, whether there is a decrease in performance of the lithium ion battery is determined, and the process is performed only when a decrease in performance is confirmed.

5. A charge/discharge device electrically connected to a lithium ion battery, the charge/discharge device comprising a controller configured to perform charge/discharge of the lithium ion battery,
wherein the controller performs a process of holding an SOC of the lithium ion battery at a fixed value that is within a range of 10% to 70%.

6. A non-transitory computer readable storage medium storing a program configured to cause a charge/discharge device electrically connected to a lithium ion battery to perform a process of holding an SOC of a lithium ion battery at a fixed value that is within a range of 10% to 70%.
